(19) United States
(12) Patent Application Publication
(10) Pub. No.: US 2026/0254913 A1
(43) Pub. Date: Aug. 27, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Takashi MOMMA, Kanagawa (JP)

(73) Assignee: FUJIFILM Business Innovation Corp., Tokyo (JP)

(21) Appl. No.: 19/314,523

(22) Filed: Aug. 29, 2025

(30) Foreign Application Priority Data
Feb. 27, 2025 (JP) 2025-030203

(51) Int. Cl. H04N 1/44; H04N 1/00; H04N 1/327

(52) U.S. Cl. CPC H04N 1/4433; H04N 1/00238; H04N 1/32786; H04N 2201/0094

(57) ABSTRACT

An information processing system includes a processor configured to: in response to communication being performed through a communication port set to disabled, acquire history information regarding the communication and block transmission and reception of data in the communication; and report, by using the acquired history information, a communication port possibly required for processing by a user, the communication port being reported with a suggestion to be set to enabled.

### CROSS-REFERENCE TO RELATED APPLICATIONS

This application is based on and claims priority under 35 USC 119 from Japanese Patent Application No. 2025-030203 filed Feb. 27, 2025.

### BACKGROUND

### (i) Technical Field

The present disclosure relates to an information processing system, a non-transitory computer readable medium, and an information processing method.

### (ii) Related Art

Japanese Unexamined Patent Application Publication No. 2024-008652 describes a communication device with enhanced security.

Japanese Unexamined Patent Application Publication No. 2022-070027 describes an information processing apparatus with reduced unavailability to a user who does not know a change of a set value of the information processing apparatus as compared with a case where after the set value is changed, processing is uniformly performed only on the basis of the changed set value. In this case, the set value is changed with secured security as compared with a case where the set value is not changed according to the use state and the operation environment.

### SUMMARY

For example, in an information processing system for a multi-function printer or the like, setting the information processing system to disable a communication port causes security to be enhanced but in contrast, possibly causes a service provided in cooperation with an external apparatus to be hindered.

It is thus desired that all of communication ports of the information processing system not be set to disabled but a communication port possibly required for processing by a user be set to enabled.

Aspects of non-limiting embodiments of the present disclosure relate to providing an information processing system, a non-transitory computer readable medium, and an information processing method that are enabled to let a user know a communication port possibly required for processing by the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: in response to communication being performed through a communication port set to disabled, acquire history information regarding the communication and block transmission and reception of data in the communication; and report, by using the acquired history information, a communication port possibly required for processing by a user, the communication port being reported with a suggestion to be set to enabled.

### BRIEF DESCRIPTION OF THE DRAWINGS

An exemplary embodiment of the present disclosure will be described in detail based on the following figures, wherein:

FIG. 1 is a view illustrating the system configuration of an image forming system of an exemplary embodiment of the present disclosure;

FIG. 2 is a block diagram illustrating the hardware configuration of an image forming apparatus in the image forming system;

FIG. 3 is a view illustrating an example of reporting a communication port with a suggestion to be set to enabled;

FIG. 4 is a table for explaining specific processing for reporting a communication port possibly required for processing by a user, the communication port being reported with a suggestion to be set to enabled;

FIG. 5 is a view illustrating an example of reporting a communication port with a suggestion to be set to enabled;

FIG. 6 is a table for explaining specific processing for reporting a communication port possibly required for processing by the user, the communication port being reported with a suggestion to be set to enabled;

FIG. 7 is a table for explaining specific processing for reporting a communication port possibly required for processing by the user, the communication port being reported with a suggestion to be set to enabled;

FIG. 8 is a table for explaining specific processing for reporting a communication port possibly required for processing by the user, the communication port being reported with a suggestion to be set to enabled; and

FIG. 9 is a flowchart for explaining the flow of processing for setting a communication port performed in the image forming apparatus.

### DETAILED DESCRIPTION

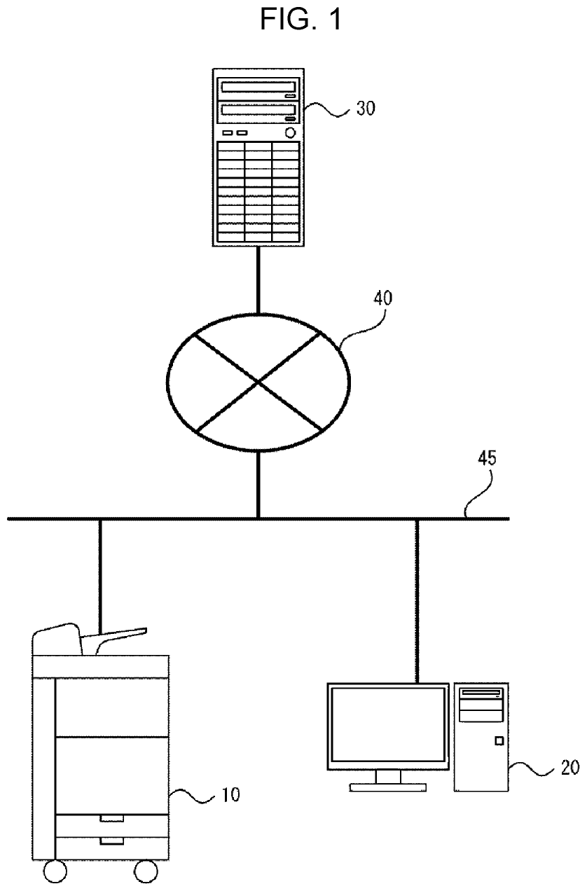

Hereinafter, an exemplary embodiment of technology of the present disclosure will be described in detail with reference to the drawings. FIG. 1 is a view illustrating the system configuration of an image forming system of the exemplary embodiment.

As illustrated in FIG. 1, the image forming system of this exemplary embodiment includes an image forming apparatus 10, a terminal apparatus 20, and a service server 30.

The image forming apparatus 10 is an apparatus having multiple functions such as a printing function, a copying function, a faxing function, and a scanning function, that is, a so-called multi-function printer. The image forming apparatus 10 is an example of an information processing system according to the technology of the present disclosure.

The terminal apparatus 20 is a terminal for transmitting a processing request to the image forming apparatus 10. For example, the terminal apparatus 20 generates print data and transmits the print data to the image forming apparatus 10. The terminal apparatus 20 is implemented by, for example, a computer, a smartphone, or the like. The image forming apparatus 10 and the terminal apparatus 20 are connected to each other via a local network 45.

The service server 30 is a server for providing various services such as optical character recognition (OCR) and translation. The service server 30 is connected to the local network 45 via the Internet 40.

The image forming apparatus 10 is capable of providing services in cooperation with the service server 30, such as transmitting image data regarding a document scanned with the image forming apparatus 10 to the service server 30 and then receiving an OCR result from the service server 30.

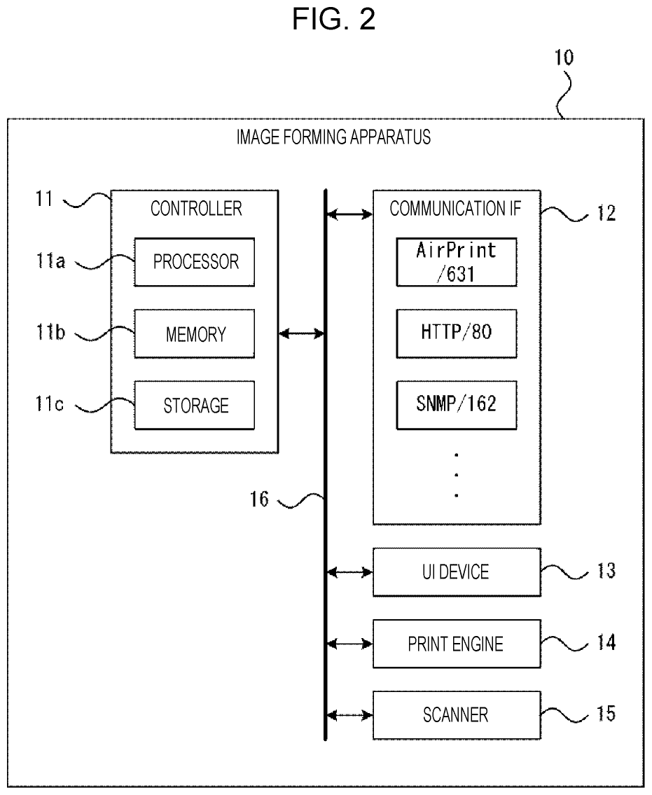

The hardware configuration of the image forming apparatus 10 of this exemplary embodiment will then be described. FIG. 2 is a block diagram illustrating the hardware configuration of the image forming apparatus 10.

As illustrated in FIG. 2, the image forming apparatus 10 includes a controller 11, a communication interface (abbreviated as a communication IF) 12, a user interface device (abbreviated as a UI device) 13, a print engine 14, and a scanner 15. These components are connected to each other via a control bus 16.

The controller 11 includes a processor 11a, a memory 11b, and a storage 11c. The processor 11a executes a predetermined process on the basis of a program read from the storage 11c and loaded into the memory 11b. The storage 11c is composed of, for example, a ROM, a HDD, a SSD, or the like. The storage 11c stores various programs, data, and the like.

In the description of this exemplary embodiment, the processor 11a reads out a program stored in the storage 11c and runs the program; however, the exemplary embodiment is not limited to this. The program may be provided in such a manner as to be recorded in a computer-readable recording medium as described above. The program may also be acquired from an external apparatus via a communication network.

The communication IF 12 is an interface for transmitting data to and from the external apparatus or the like and includes multiple communication ports supporting respective services such as AirPrint (registered trademark), hypertext transfer protocol (HTTP), and simple network management protocol (SNMP).

The UI device 13 is a device for a user to receive and input information, such as a touch panel and/or buttons. The print engine 14 prints an image on the recording medium such as a printing sheet after being subjected to processes of charging, light exposure, development, fixing, and the like. The scanner 15 reads a document placed on the image forming apparatus 10 and outputs image data in a set image format.

In the image forming apparatus 10, setting communication ports included in the communication IF 12 to disabled causes security to be enhanced but in contrast, possibly causes a service provided in cooperation with the service server 30 to be hindered.

It is thus desired that all of the communication ports of the image forming apparatus 10 not be set to disabled but a communication port possibly required for processing by the user be set to enabled.

Hence, in response to communication being performed through a communication port set to disabled, the controller 11 of the image forming apparatus 10 of this exemplary embodiment acquires history information regarding the communication, blocks transmission and reception of data in the communication, and reports the communication port possibly required for processing by the user, by using the acquired history information, the communication port being reported with a suggestion to be set to enabled.

In response to the communication being performed through the communication port set to disabled, the controller 11 may establish the communication, block the transmission and reception of data in the communication, acquire history information regarding the communication as an anomaly record, and then discard the established communication. The controller 11 may acquire the history information regarding the communication as an anomaly record in the state where the transmission and reception of data in the communication is blocked without establishing the communication.

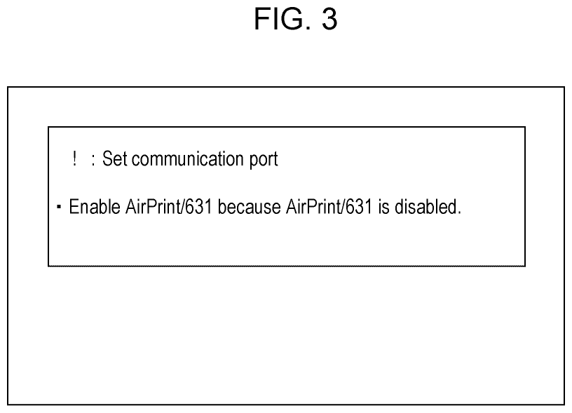

As the reporting of the communication port with the suggestion to be set to enabled, for example, the message “Enable AirPrint/631 because AirPrint/631 is disabled.” as illustrated in FIG. 3 may be displayed on the display screen of the touch panel. Apart from this, any reporting may be performed, for example, a report to an administrator user may be generated and transmitted, attached to e-mail.

In the image forming apparatus 10 of this exemplary embodiment, in response to a security measure being set, the controller 11 may set the communication ports of multiple types to disabled collectively.

Setting a security measure is setting only for enhancing security and may be, for example, any of an on setting from on/off choices, a setting from high, middle, and low choices, and a setting at a specific level or higher from multiple level choices such as 5, 4, 3, 2, and 1.

The controller 11 may also exclude a communication port separately set to disabled from the communication port to be reported with the suggestion to be set to enabled.

First, an example of setting a communication port to enabled or disabled will be described. In the image forming apparatus 10 of this exemplary embodiment, any of low security, high security (not to be reported), and high security (to be reported) is settable on the screen for collectively setting communication port security. The administrator user may perform any setting from these choices on the image forming apparatus 10.

If the low security is set on the screen for collectively setting communication port security, the controller 11 sets all of the communication ports to enabled.

If the high security is set on the screen for collectively setting communication port security, the controller 11 sets all of the communication ports to disabled.

Even though the high security is set on the screen for collectively setting communication port security, the controller 11 may separately set a subset of the communication ports to enabled in accordance with instruction input from the administrator user.

In addition, if the mode “not to be reported” is set in the high security setting, and if communication is performed through a communication port set to disabled, the controller 11 does not establish the communication.

If the mode “to be reported” is set in the high security setting, the controller 11 establishes the communication, acquire history information regarding the communication, and blocks transmission and reception of data in the communication.

Specific processing for reporting a communication port possibly required for processing by the user in a state where there is a communication port set to disabled will then be described in detail, the communication port being reported with a suggestion to be set to enabled.

As a first specific example, in response to the count of occurrences of an anomaly at a communication port set to disabled exceeding a threshold set in advance, the controller 11 may report the communication port with a suggestion to be set to enabled.

The threshold for the count of occurrences of an anomaly may be a threshold based on the sum of the count of occurrences of an anomaly at the communication port regardless of a communication partner or a threshold based on the count of occurrences of an anomaly in communication with one communication partner.

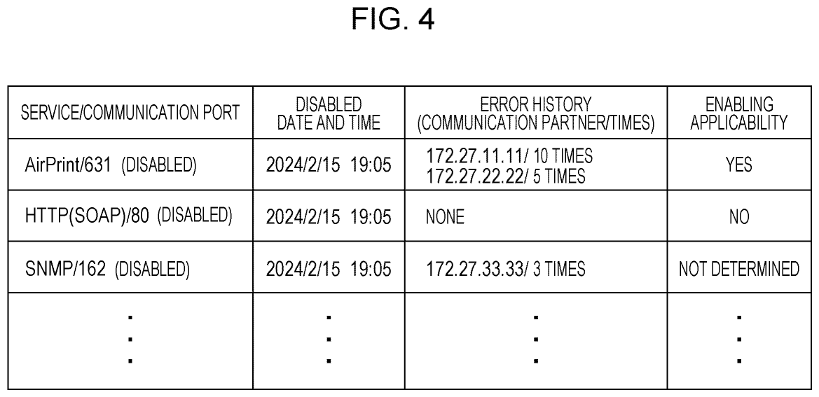

For example, if ten times is set as the threshold based on the sum of the count of occurrences of an anomaly at the communication port regardless of the communication partner, as illustrated in FIG. 4, AirPrint/631 of the all of the communication ports that has an anomaly ten times or more is to be reported with a suggestion to be set enabled.

A communication port (SNMP/162 in FIG. 4) having an anomaly the count of which does not exceed the threshold but is one or more may also be reported with a suggestion to be set to enabled.

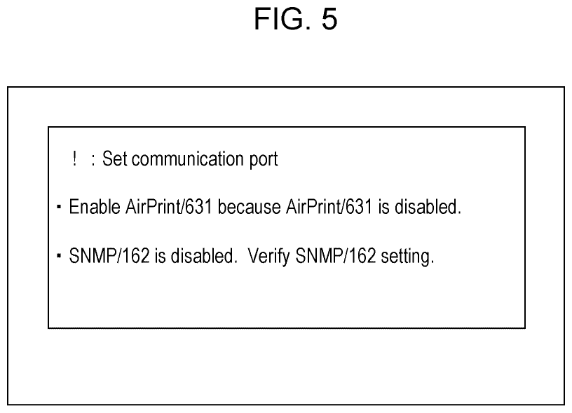

To report a communication port with a suggestion to be set to enabled, for example, as illustrated in FIG. 5, the message “SNMP/162 is disabled. Verify SNMP/162 setting.” may be displayed on the display screen of the touch panel.

In the first specific example, the controller 11 may set a threshold to a higher numerical value for a communication port having higher security risk.

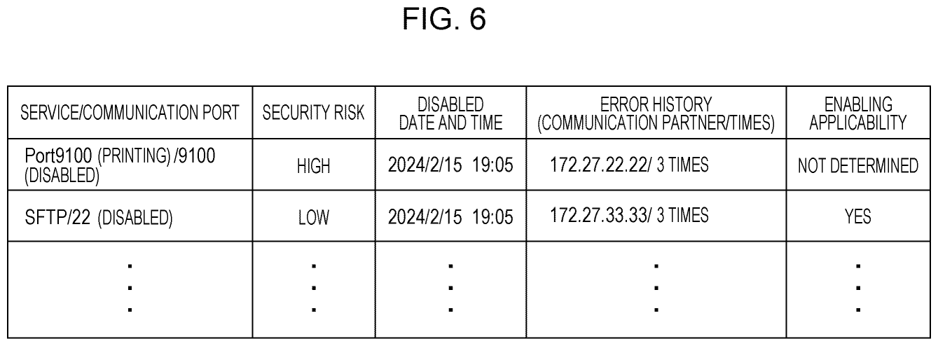

For example, as illustrated in FIG. 6, two types of communication ports are set to disabled: Port9100 (printing)/9100 with a not encrypted communication protocol and having high security risk; and SSH file transfer protocol (SFTP)/22 with an encrypted communication protocol and having low security risk.

In this case, for example, “2” may be set as a threshold for SFTP/22 having low security risk, “5” may be set as a threshold for Port9100 (printing)/9100 having high security risk, and SFTP/22 having low security risk may thereby be set to be more likely to be reported.

Subsequently, as a second specific example, the controller 11 may decide a communication port to be reported with a suggestion to be set to enabled according to history information regarding a communication port set to enabled and report the decided communication port with the suggestion to be set to enabled.

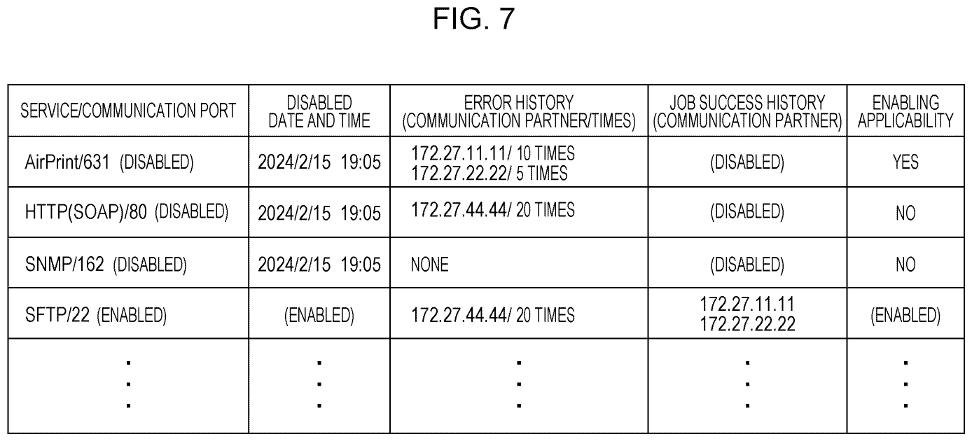

For example, as illustrated in FIG. 7, transmission and reception of data to and from communication partners with 172.27.11.11 and 172.27.22.22 have succeed at SFTP/22 set to enabled.

In this case, AirPrint/631 on which anomalies occur in the communication with the same communication partners with 172.27.11.11 and 172.27.22.22 is to be reported with a suggestion to be set enabled.

As a third specific example, in newly using a communication port set to disabled due to update of software for controlling the image forming apparatus 10, the controller 11 may report the communication port with a suggestion to be set to enabled.

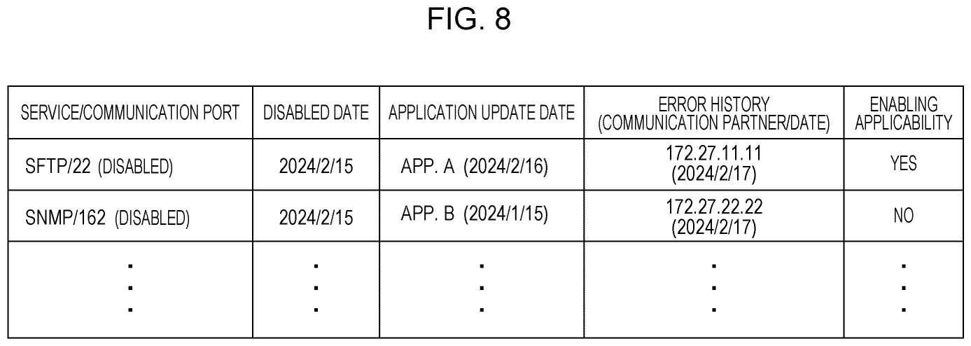

For example, as illustrated in FIG. 8, SFTP/22 is disabled on 2024 Feb. 15, Application A is updated on 2024 Feb. 16, and then SFTP/22 is newly used. In this case, SFTP/22 is to be reported with a suggestion to be set enabled.

Simple Network Management Protocol (SNMP)/162 is not reported with a suggestion to be set to enabled because Application B using SNMP/162 has been updated on 2024 Jan. 15 before being disabled on 2024 Feb. 15.

As a fourth specific example, the controller 11 may decide a communication port to be reported with a suggestion to be set to enabled on the basis of a communication partner involving an anomaly having occurred at the communication port set to disabled and report the decided communication port with the suggestion to be set to enabled.

For example, if a communication port has an anomaly in response to a communication request from the inside of the local network 45, the communication request is considered to be highly likely to be a communication try from an authorized user (for example, an employee), and the communication port having the anomaly is to be reported with a suggestion to be set to enabled.

If a communication port has an anomaly in response to a communication request from the outside of the local network 45, the communication request is considered to be highly likely to be a communication try from a user other than an authorized user (for example, an employee), and the communication port having the anomaly is not to be reported with a suggestion to be set to enabled.

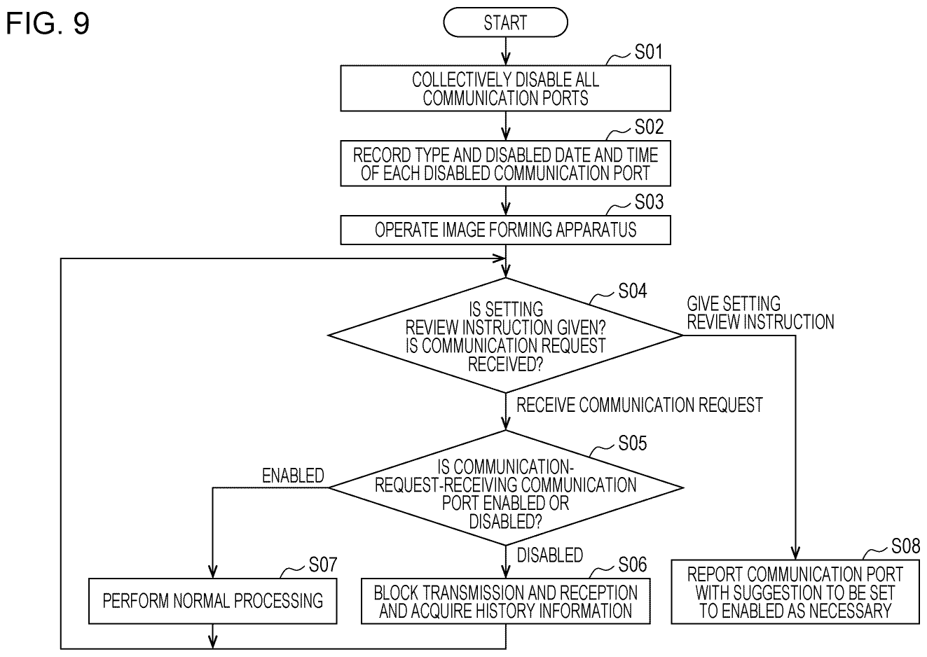

The flow of processing for setting a communication port performed in the image forming apparatus 10 of this exemplary embodiment will then be described with reference to a flowchart in FIG. 9.

As illustrated in FIG. 9, in step S01, the controller 11 of the image forming apparatus 10 first sets all communication ports to disabled collectively in accordance with instruction input from the administrator user.

In step S02, the controller 11 then records the type and the disabled date and time of each disabled communication port.

In step S03, the controller 11 then causes the image forming apparatus 10 to operate.

In step S04, the controller 11 first determines whether a setting review instruction of a communication port is given or a communication request is received.

If it is determined that a communication request is received in step S04, the controller 11 determines in step S05 whether the communication port receiving the communication request is set to enabled or disabled.

If it is determined in step S05 that the communication port receiving the communication request is set to disabled, the controller 11, in step S06, establishes communication, acquires history information regarding the communication, blocks transmission and reception of data in the communication, and moves to step S04.

If it is determined in step S05 that the communication port receiving the communication request is set to enabled, the controller 11, in step S07, performs normal processing, that is, establishes communication, acquires history information regarding the communication, performs transmission and reception of data in the communication, and moves to step S04.

If it is determined in step S04 that a setting review instruction is given, the controller 11 reports a communication port with a suggestion to be set to enabled in step S08 as necessary (that is, if there is a communication port possibly required for processing by the user).

### Modification

The image forming system of the exemplary embodiment of the present disclosure has heretofore been described; however, the technology of the present disclosure is not limited to the exemplary embodiment above and may be appropriately modified.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The system in the technology of the present disclosure includes both of a system including multiple devices and a system including one device.

The technology of the present disclosure is also applicable to a program and a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system includes:
a processor configured to:
   in response to communication being performed through a communication port set to disabled, acquire history information regarding the communication and block transmission and reception of data in the communication; and
   report, by using the acquired history information, a communication port possibly required for processing by a user, the communication port being reported with a suggestion to be set to enabled.
      (((2)))

In the information processing system according to (((1))),
the communication port includes multiple communication ports, and
the processor is configured to:
   in response to a security measure being set, set the communication ports of respective types to disabled collectively.
      (((3)))

In the information processing system according to (((2))),
the processor is configured to:
   exclude a communication port separately set to disabled from the communication port to be reported with the suggestion to be set to enabled.
      (((4)))

In the information processing system according to any one of (((1))) to (((3))),
the processor is configured to:
   in response to a count of an occurrence of an anomaly at a communication port set to disabled exceeding a threshold set in advance, report the disabled communication port with the suggestion to be set to enabled.
      (((5)))

In the information processing system according to (((4))),
the processor is configured to:
   set a threshold to a higher numerical value for a communication port having higher security risk.
      (((6)))

In the information processing system according to any one of (((1))) to (((3))),
the processor is configured to:
   decide the communication port to be reported with the suggestion to be set to enabled, the communication port being reported on a basis of history information regarding the communication port set to enabled and report the decided communication port with the suggestion to be set to enabled.
      (((7)))

In the information processing system according to any one of (((1))) to (((3))),
the processor is configured to:
   in newly using the communication port set to disabled due to update of software for controlling the information processing system, report the communication port with the suggestion to be set to enabled.
      (((8)))

In the information processing system according to any one of (((1))) to (((7))),
the processor is configured to:
   decide the communication port to be reported with the suggestion to be set to enabled, the communication port being reported on a basis of a communication partner involving an anomaly having occurred at the communication port set to disabled and report the decided communication port with the suggestion to be set to enabled.
      (((9)))

A program causes a computer to execute a process including:
in response to communication being performed through a communication port set to disabled, acquiring history information regarding the communication and blocking transmission and reception of data in the communication; and
reporting a communication port possibly required for processing by a user, the reporting being performed by using the acquired history information and with a suggestion to be set to enabled.

What is claimed is:

1. An information processing system comprising:
a processor configured to:
in response to communication being performed through a communication port set to disabled, acquire history information regarding the communication and block transmission and reception of data in the communication; and
report, by using the acquired history information, a communication port possibly required for processing by a user, the communication port being reported with a suggestion to be set to enabled.

2. The information processing system according to claim 1,
wherein the communication port includes a plurality of communication ports, and
wherein the processor is configured to:
in response to a security measure being set, set the communication ports of respective types to disabled collectively.

3. The information processing system according to claim 2,
wherein the processor is configured to:
exclude a communication port separately set to disabled from the communication port to be reported with the suggestion to be set to enabled.

4. The information processing system according to claim 1,
wherein the processor is configured to:
in response to a count of an occurrence of an anomaly at a communication port set to disabled exceeding a threshold set in advance, report the disabled communication port with the suggestion to be set to enabled.

5. The information processing system according to claim 4,
wherein the processor is configured to:
set a threshold to a higher numerical value for a communication port having higher security risk.

6. The information processing system according to claim 1,
wherein the processor is configured to:
decide the communication port to be reported with the suggestion to be set to enabled, the communication port being reported on a basis of history information regarding the communication port set to enabled and report the decided communication port with the suggestion to be set to enabled.

7. The information processing system according to claim 1,
wherein the processor is configured to:
in newly using the communication port set to disabled due to update of software for controlling the information processing system, report the communication port with the suggestion to be set to enabled.

8. The information processing system according to claim 1,
wherein the processor is configured to:
decide the communication port to be reported with the suggestion to be set to enabled, the communication port being reported on a basis of a communication partner involving an anomaly having occurred at the communication port set to disabled and report the decided communication port with the suggestion to be set to enabled.

9. A non-transitory computer readable medium storing a program causing a computer to execute a process comprising:
in response to communication being performed through a communication port set to disabled, acquiring history information regarding the communication and blocking transmission and reception of data in the communication; and
reporting a communication port possibly required for processing by a user, the reporting being performed by using the acquired history information and with a suggestion to be set to enabled.

10. An information processing method comprising:
in response to communication being performed through a communication port set to disabled, acquiring history information regarding the communication and blocking transmission and reception of data in the communication; and
reporting a communication port possibly required for processing by a user, the reporting being performed by using the acquired history information and with a suggestion to be set to enabled.
